(19) United States
(12) Patent Application Publication
(10) Pub. No.: US 2013/0121038 A1
(43) Pub. Date: May 16, 2013

(54) CONVERTER, METHOD FOR CONTROLLING THE SAME, AND INVERTER

(71) Applicants: Dong Kyun RYU, Seoul (KR); Tae Won LEE, Gyeonggi-do (KR); Young Ho KIM, Seoul (KR); Chung Yuen WON, Gyeonggi-do (KR); Yong Hyok JI, Gyeonggi-do (KR)

(72) Inventors: Dong Kyun RYU, Seoul (KR); Tae Won LEE, Gyeonggi-do (KR); Young Ho KIM, Seoul (KR); Chung Yuen WON, Gyeonggi-do (KR); Yong Hyok JI, Gyeonggi-do (KR)

(73) Assignee: SAMSUNG Electro-Mechanics Co., Ltd./SUNGKYUNKWAN UNIVERSITY FOUNDATION FOR CORPORATE COLLABORATION

(21) Appl. No.: 13/482,801

(22) Filed: May 29, 2012

(30) Foreign Application Priority Data
Nov. 11, 2011 (KR) 10-2011-0117766

(51) Int. Cl. H02M 3/335

(52) U.S. Cl. 363/21.14

(57) ABSTRACT

Disclosed herein are a converter, a method for controlling the same, and an inverter. The converter includes: an input terminal having power input thereto; a first converter unit converting the power input to the input terminal to thereby output the converted power to an output terminal; and a second converter unit connected between the input terminal and the output terminal while being in parallel with the first converter unit, wherein each of the first and second converter units includes an active clamp unit provided at a primary side thereof and a synchronous rectifying unit provided at a secondary side thereof.

### CROSS REFERENCE(S) TO RELATED APPLICATIONS

This application claims the benefit under 35 U.S.C. Section 119 of Korean Patent Application Serial No. 10-2011-0117766, entitled “Converter, Method for Controlling the Same, and Inverter.” filed on Nov. 11, 2011, which is hereby incorporated by reference in its entirety into this application.

### BACKGROUND OF THE INVENTION

1. Technical Field

The present invention relates to a converter, a method for controlling the same, and an inverter.

2. Description of the Related Art

A converter has been widely used in order to convert alternate current power into a predetermined direct current power or boost and output low voltage input power.

Particularly, in order to boost the low voltage, a flyback converter has been mainly used.

However, in a general flyback converter according to the related art, a ripple of output current is large, and withstand voltage and capacity of a secondary side rectifying diode should be high.

Meanwhile, Patent Document 1 discloses an interleaved flyback light emitting diode (LED) driving device. In Patent Document 1, a technology of including two transformers in order to solve the problem of the general flyback converter according to the related art described above has been proposed.

However, a converter disclosed in Patent Document 1 transfers current induced to a secondary side to an output capacity only through a diode. Therefore, since a diode having large withstand voltage should be used as voltage or current induced to the secondary side becomes large, a manufacturing cost of the entire converter increases, and stress applied to the diode increases, such that a lifespan of the diode decreases.

Further, a leakage flux is generated in a transformer, which is one of main elements of the flyback converter. A virtual leakage inductor formed by the leakage flux resonates with a parasitic capacitor of a switch connected to the transformer to generate a voltage spike at the time of a switching operation, thereby increasing stress applied to the converter, or the like, and decreasing efficiency of power transfer due to power that is not transferred to the secondary side. However, converters according to the related art including the converter disclosed in the Patent Document 1 do not efficiently solve these problems.

### RELATED ART DOCUMENT

### Patent Document

(Patent Document 1) Patent Document 1: Korean Patent Laid-Open Publication No. 10-2009-0006667

### SUMMARY OF THE INVENTION

An object of the present invention is to provide a converter capable of reducing power loss due to a leakage flux, a voltage spike caused in a switch, stress applied to a secondary side diode and output capacitor, and switching conduction loss, a method for controlling the same, and an inverter.

According to an exemplary embodiment of the present invention, there is provided a converter including: an input terminal having power input thereto; a first converter unit converting the power input to the input terminal to thereby output the converted power to an output terminal; and a second converter unit connected between the input terminal and the output terminal while being in parallel with the first converter unit, wherein each of the first and second converter units includes an active clamp unit provided at a primary side thereof and a synchronous rectifying unit provided at a secondary side thereof.

Each of the first and second converter units may include: a primary coil having one end connected to the input terminal; a main switch having a first terminal connected to the other end of the primary coil and a second terminal connected to the input terminal; and a secondary coil magnetically coupled to the primary coil and having one end connected to the output terminal.

The active clamp unit may include: a sub-switch having a first terminal connected between the input terminal and the primary coil; and a clamp capacitor having one end connected to a second terminal of the sub-switch and the other end connected between the primary coil and the main switch.

The main switch and the sub-switch may be provided with an anti-parallel diode.

The synchronous rectifying unit may include: a synchronous switch connected between the other end of the secondary coil and the output terminal; and an anti-parallel diode connected to the synchronous switch.

The synchronous switch may be changed from a turn-off state to a turn-on state after the main switch is changed from a turn-on state to a turn-off state, the sub-switch may be changed from a turn-off state to a turn-on state after the synchronous switch is changed from the turn-on state to the turn-off state, and the main switch may be changed from the turn-off state to the turn-on state after the sub-switch is changed from the turn-on state to the turn-off state.

The main switch of the second converter unit may become the turn-on state only in the case in which the main switch of the first converter unit is in the turn-off state.

A time in which the synchronous switch of the first converter unit is turned on may be prior to a time in which the main switch of the second converter unit is turned on, and a time in which the synchronous switch of the first converter unit is turned off may be between a time in which the main switch of the second converter unit is turned on and a time in which the sub-switch of the first converter unit is turned on.

According to another exemplary embodiment of the present invention, there is provided a converter including: an input terminal having power input thereto; a first primary coil having one end connected to the input terminal; a first main switch having a first terminal connected to the other end of the first primary coil and a second terminal connected to the input terminal; a first active clamp unit connected in parallel with the first primary coil; a first secondary coil magnetically coupled to the first primary coil and having one end connected to an output terminal; a first synchronous switch having a first terminal connected to the other end of the first secondary coil and a second terminal connected to the output terminal; a second primary coil having one end connected to the input terminal; a second main switch having a first terminal connected to the other end of the second primary coil and a second terminal connected to the input terminal; a second active clamp unit connected in parallel with the second primary coil; a second secondary coil magnetically coupled to the second primary coil and having one end connected to an output terminal; and a second synchronous switch having a first terminal connected to the other end of the second secondary coil and a second terminal connected to the output terminal.

The first active clamp unit may include: a first sub-switch having a first terminal connected between the first primary coil and the input terminal; and a first clamp capacitor having one end connected to a second terminal of the first sub-switch and the other end connected between the first primary coil and the first main switch, and the second active clamp unit may include: a second sub-switch having a first terminal connected between the second primary coil and the input terminal; and a second clamp capacitor having one end connected to a second terminal of the second sub-switch and the other end connected between the second primary coil and the second main switch.

The converter may further include an anti-parallel diode connected to each of the first main switch, the first sub-switch, the second main switch, and the second sub-switch.

The converter may further include an anti-parallel diode connected to each of the first and second synchronous switches.

The first synchronous switch may be changed from a turn-off state to a turn-on state after the first main switch and the second sub-switch are changed from a turn-on state to a turn-off state, the second main switch may be changed from a turn-off state to a turn-on state in a state in which the first synchronous switch is turned on, the first sub-switch may be changed from a turn-off state to a turn-on state after the first synchronous switch is changed from the turn-on state to the turn- off state, the second synchronous switch may be changed from a turn-off state to a turn-on state after the first sub-switch and the second main switch are changed from the turn-on state to the turn-off state, and the first main switch may be changed from the turn-off state to the turn-on state in a state in which the second synchronous switch is turned on.

According to still another exemplary embodiment of the present invention, there is provided an inverter including: the converter as described above; an output capacitor connected to the output terminal; and an inverter unit connected in parallel with the output capacitor and converting direct current into alternate current.

The inverter may further include a filter unit connected to the inverter unit and removing noise.

According to still another exemplary embodiment of the present invention, there is provided a method for controlling the converter, the method including: (A) turning on the first main switch, thereby supplying current to the first primary coil; (B) turning on the first synchronous switch after turning off the first main switch, thereby transferring current induced to the first primary coil to the output terminal; (C) turning on the first sub-switch after turning off the first synchronous switch; and (D) turning off the first sub-switch.

According to still another exemplary embodiment of the present invention, there is provided a method for controlling the converter, the method including: (a) turning on the first main switch in a state in which the second synchronous switch is turned on; (b) turning on the second sub-switch after turning off the second synchronous switch; (c) turning on the first synchronous switch after turning off the first main switch and the second sub-switch; (d) turning on the second main switch in a state in which the first synchronous switch is turned on; (e) turning on the first sub-switch after turning off the first synchronous switch; and (f) turning on the second synchronous switch after turning off the second main switch and the first sub-switch.

### BRIEF DESCRIPTION OF THE DRAWINGS

FIG. 1 is a view showing an inverter according to an exemplary embodiment of the present invention;

FIGS. 2A to 2J are views describing an operation principle of the converter according to the exemplary embodiment of the present invention;

FIG. 3 is a view schematically showing switch control signals for each period and relationships between current and voltage in main elements according to the exemplary embodiment of the present invention;

FIG. 4 is a view schematically showing operation waveforms in the case in which main elements of the inverter according to the exemplary embodiment of the present invention are in a normal state;

FIGS. 5A to 5D are views describing an operation mode of a synchronous rectifying unit of the converter according to the exemplary embodiment of the present invention;

FIG. 6 is a view schematically showing a switching variable region of a synchronous rectifier during a grid voltage frequency;

FIG. 7A is a view schematically showing voltage waveforms of a synchronous switch during a process in which a leakage inductor of a single flyback inverter is charged with current;

FIG. 7B is a view schematically showing voltage waveforms of a synchronous switch during a process in which a leakage inductor of an interleaved flyback inverter is charged with current;

FIG. 8 is a view schematically showing simulation results of operation waveforms in main elements of the converter according to the exemplary embodiment of the present invention during a switching period; and

FIG. 9 is a view schematically showing simulation results of operation waveforms in main elements of the inverter according to the exemplary embodiment of the present invention during a grid period.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

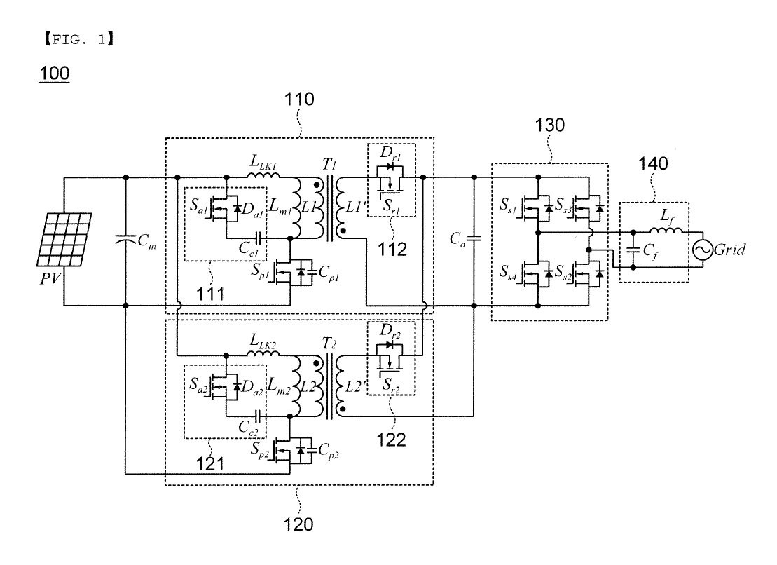

FIG. 1 is a view showing an inverter 100 according to an exemplary embodiment of the present invention.

Referring to FIG. 1, the inverter 100 according to the exemplary embodiment of the present invention may be configured to include an input terminal, an output terminal, a converter, an inverter unit 130, and a filter unit 140.

Direct current power may be applied to the input terminal. A case in which power generated from a photovoltaic cell is charged in an input capacitor Cin and then applied to the input terminal is shown in FIG. 1. However, FIG. 1 shows an example in which the inverter 100 according to the embodiment of the present invention is applied and thus does not limit the scope of the present invention.

Generally, in a photovoltaic module, direct current voltage of 45 V or less is output. Therefore, in order to use voltage generated through photovoltaic power generation as commercial power, the direct current voltage needs to be boosted to 220 V and converted into alternate current voltage. Then, the converted alternate current voltage may be connected to a grid.

Therefore, the inverter 100 connecting the photovoltaic cell to the grid to allow the photovoltaic cell to be used as a power supply requires high boosting and high efficiency characteristics and is advantageous as a ripple of input current becomes small.

Meanwhile, the converter may be mainly divided into an insulation type voltage source converter and an insulation type current source converter.

The insulation type voltage source converter has voltage drop type circuit characteristics, a large ripple of input current, and large stress applied to an output diode.

The insulation type current source converter has an advantage in which a ripple of input current is small as compared to the voltage source converter in a system converting low voltage into high voltage. A typical example of the insulation type current source converter may include a flyback converter.

As shown in FIG. 1, the inverter 100 according to the exemplary embodiment of the present invention has a converter structure developed based on the flyback converter in order to solve problems such as a voltage spike in an inner portion of the converter, switching loss, conduction loss of a diode, and the like, and reduce ripple current.

The output terminal may include an output capacitor C0 (Cₒ) charged with voltage and current output from the converter, and direct current power charged in the output capacitor Cₒ is converted into alternate current power through the inverter unit 130 capable of being implemented in various schemes and then connected to a grid.

Here, the inverter 100 according to an exemplary embodiment of the present invention may further include the filter unit 140 removing noise from the power passing through the inverter unit 130.

The converter according to the exemplary embodiment of the present invention may include first and second converter units 110 and 120.

Here, the first and second converter units 110 and 120 may have the same structure and be connected between the input terminal while being in parallel with each other and the output terminal to thereby be formed in an interleaved structure.

The first converter unit 110 includes a first transformer T1 including a first primary coil L1 (L₁) and a first secondary coil L1′ (L₁′) and a first main switch Sₚ₁, similar to a basic configuration of a general flyback converter.

Furthermore, a first active clamp unit 111 is connected in parallel with the first primary coil L₁, and a first synchronous rectifying unit 112 including a first synchronous switch Sᵣ₁ and an anti-parallel diode Dᵣ₁ instead of a general output diode is connected between the first secondary coil L₁′ and the output terminal.

The first active clamp unit 111 may include a first sub-switch Sₐ₁, an anti-parallel diode Dₐ₁, and a first clamp capacitor C_{c1}.

The first sub-switch Sₐ₁ has a first terminal connected between the first primary coil L₁ and the input terminal and a second terminal connected to one end of the first clamp capacitor C_{c1}.

The first clamp capacitor C_{c1}, is connected between the first primary coil L₁ and the first main switch Sₚ₁.

The second converter unit 120 also includes a second transformer T2 including a second primary coil L₂ and a second secondary coil and a second main switch Sₚ₂.

Further, a second active clamp unit 121 is connected in parallel with the second primary coil L₂, and a second synchronous rectifying unit 122 including a second synchronous switch Sᵣ₂ and an anti-parallel diode Dᵣ₂ instead of a general output diode is connected between the second secondary coil and the output terminal.

The second active clamp unit 121 may include a second sub-switch Sₐ₂, an anti-parallel diode Dₐ₂, and a second clamp capacitor C_{c2}.

The second sub-switch Sₐ₂ has a first terminal connected between the second primary coil L₂ and the input terminal and a second terminal connected to one end of the second clamp capacitor C_{c2}.

The second clamp capacitor C_{c2} is connected between the second primary coil L₂ and the second main switch Sₚ₂.

Meanwhile, a first magnetization inductor Lₘ₁, a first leakage inductor L_{LK1}, the first main switch Sₚ₁, a parasitic capacitor Cₚ₁, a second magnetization inductor Lₘ₂, a second leakage inductor L_{LK2}, the second main switch Sₚ₂, and a parasitic capacitor Cₚ₂ are shown in FIG. 1.

It may be easily appreciated by those skilled in the art that the magnetization inductor and the leakage inductor are virtual components described in order to reflect characteristics due to a leakage flux of the transformer, and the parasitic capacitor Cp of the main switch is also a virtual component describing parasitic components present in the switch.

In addition, the first main switch Sₚ₁, the second main switch Sₚ₂, the first sub-switch Sₐ₁, the second sub-switch Sₐ₂, the first synchronous switch Sᵣ₁, and the second synchronous switch Sᵣ₂ described above may be turned on or off according to a control signal applied from a separately provided controlling unit (not shown).

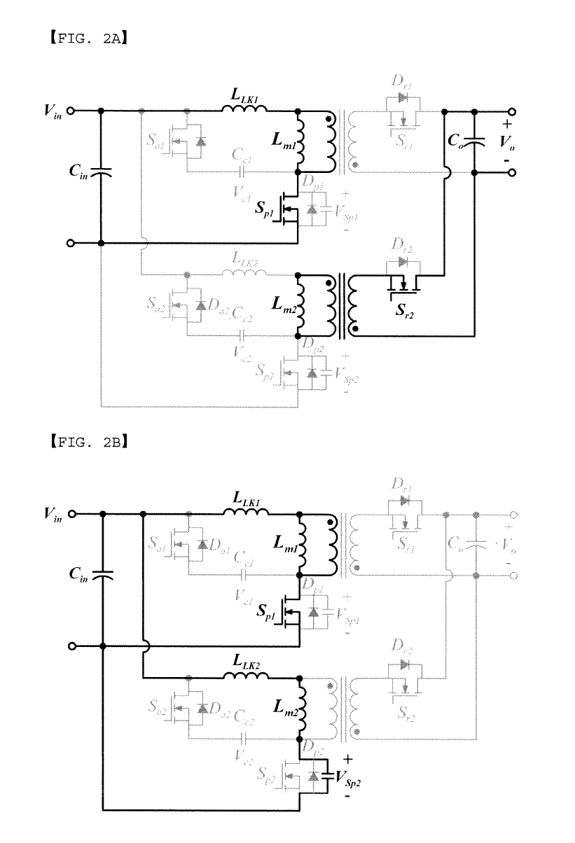

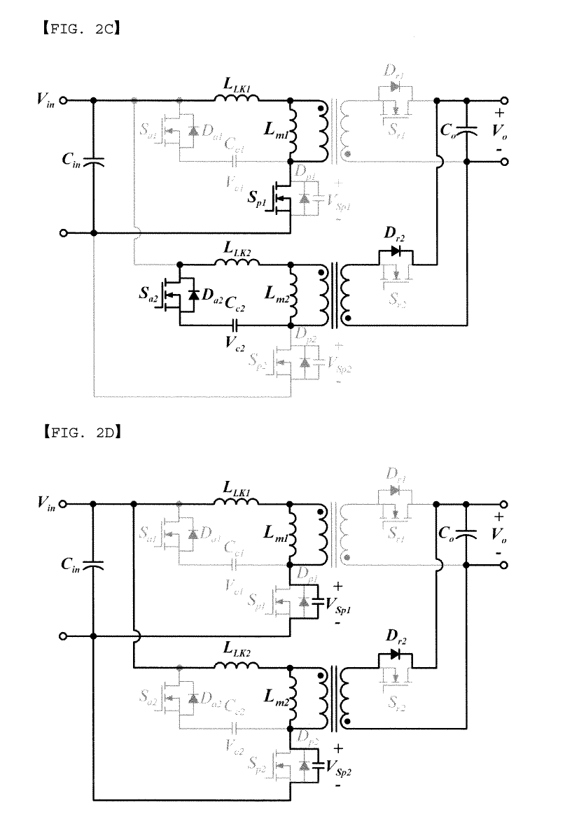

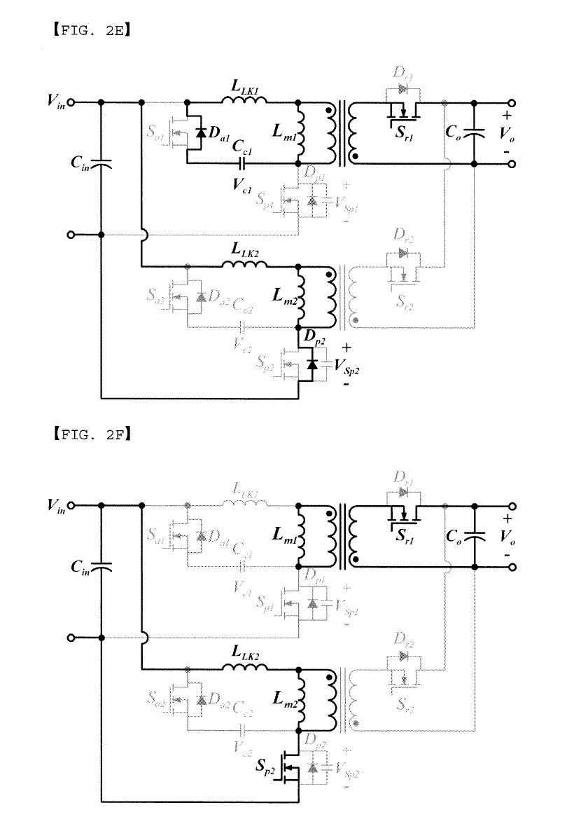

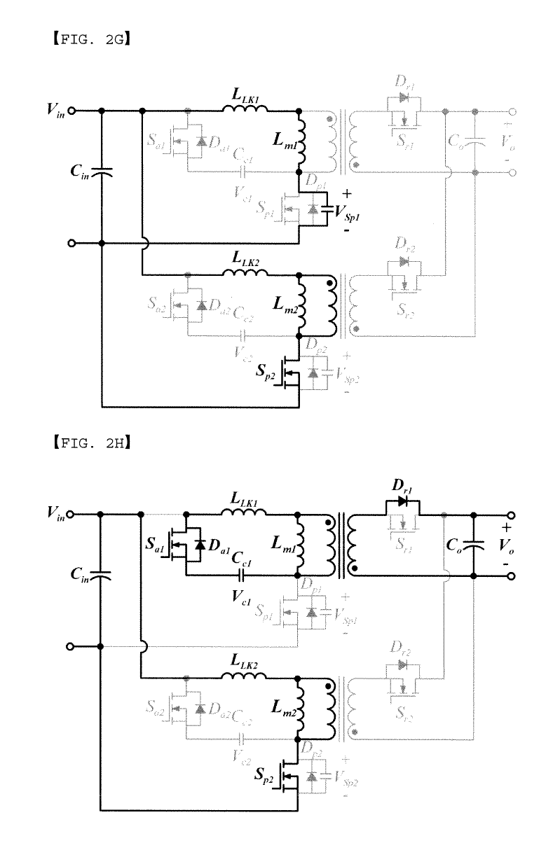

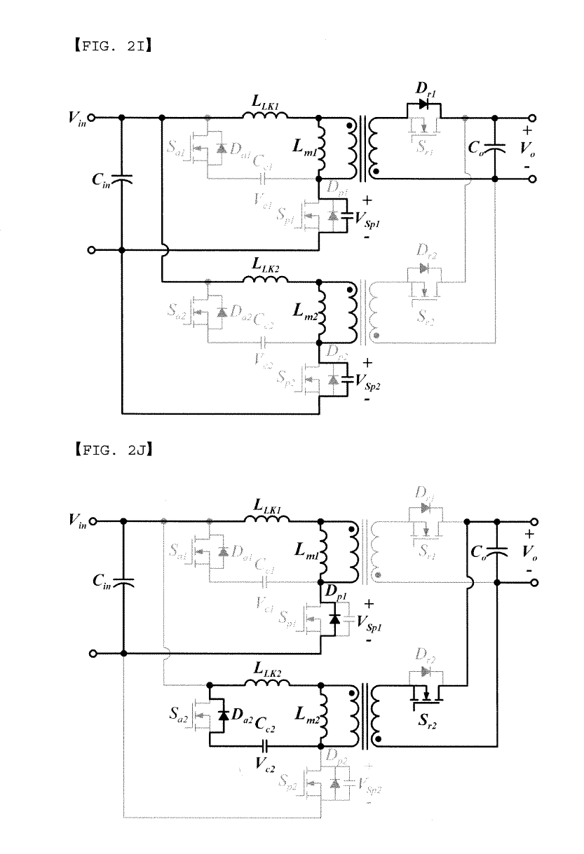

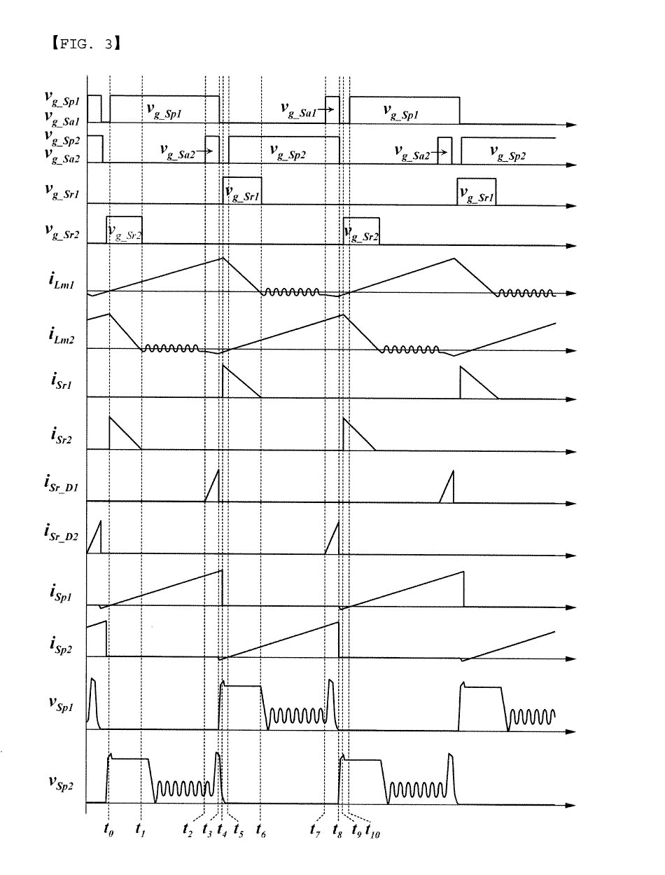

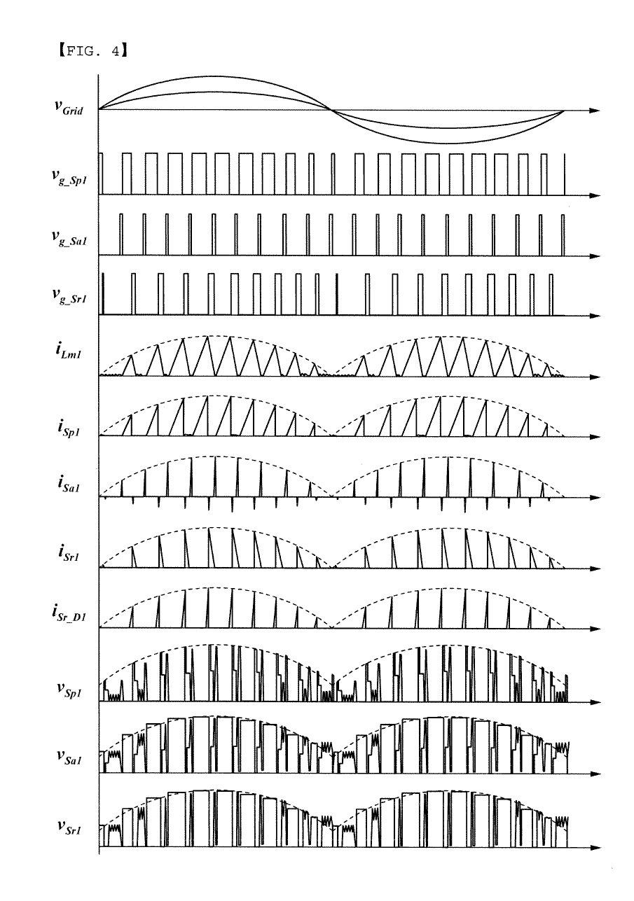

FIGS. 2A to 2J are views describing an operation principle of the converter according to the exemplary embodiment of the present invention; and FIG. 3 is a view schematically showing switch control signals for each period and relationships between current and voltage in main elements according to the exemplary embodiment of the present invention.

Hereinafter, an operation principle of the converter according to the exemplary embodiment of the present invention will be described in detail with reference to FIGS. 2A to 3.

In order to help the understanding, a period from t₀ to t₁, a period from t₁ to t₂, a period from t₂ to t₃, a period from t₃ to t₄, and a period from t₄ to t₅ in FIG. 3 will be described as Mode 1 (FIG. 2A), Mode 2 (FIG. 2B), Mode 3 (FIG. 2C), Mode 4 (FIG. 2D), and Mode 5 (FIG. 2E), respectively.

<Mode 1>

The first main switch Sₚ₁ of the first converter unit 110 is turned on and then maintained in a turn-on state, and the first sub-switch is in a turn-off state. Therefore, power charged in the input capacitor Cᵢₙ is accumulated in the first magnetization inductor Lₘ₁, such that current of the first magnetization inductor Lₘ₁ increases linearly.

Meanwhile, the second main switch Sₚ₂ of the second converter unit 120 is in a turn-off state, and the second synchronous switch Sᵣ₂ is maintained in a turn-on state, such that energy accumulated in the second magnetization inductor Lₘ₂ is induced to the second secondary coil L₂′ and passes through the second synchronous switch Sᵣ₂ to thereby be charged in the output capacitor Cₒ. At this time, current of the second magnetization inductor Lₘ₂ decreases linearly to thereby become 0. In addition, energy accumulated in the output capacitor Cₒ is transferred to the inverter unit 130 to thereby be converted into alternate current.

<Mode 2>

The first main switch Sₚ₁ of the first converter unit 110 is maintained in a turn-on state, such that the energy is continuously accumulated in the first magnetization inductor Lₘ₁ and the current of the first magnetization inductor Lₘ₁ increases linearly.

Meanwhile, the second synchronous switch Sᵣ₂ of the second converter unit 120 is turned off and is maintained in a turn-off state, and parasitic resonance is generated between the second magnetization inductor Lₘ₂ and the parasitic capacitor of the second main switch Sₚ₂.

<Mode 3>

The first converter unit 110 performs the same operation as the operation in the previous mode.

Meanwhile, the second sub-switch Sₐ₂ of the second converter unit 120 is turned on and is maintained in a turn-on state, and energy accumulated in the second leakage inductor L_{LK2} is induced to the second secondary coil L₂′ through the second clamp capacitor C_{c2} and the second primary coil L₂. In addition, current induced to the second secondary coil L₂′ passes through the anti-parallel diode Dᵣ₂ of the second synchronous switch Sᵣ₂ to thereby be charged in the output capacitor Cₒ and finally transferred to the inverter unit 130.

At this time, the current of the second magnetization inductor Lₘ₂ increase in an inverse direction but may have a magnitude smaller than leakage current.

<Mode 4>

The first main switch Sₚ₁ of the first converter unit 110 is turned off, the parasitic capacitor Cₚ₁ of the first main switch is charged with the current of the first magnetization inductor Lₘ₁, and voltage Vₛₚ₁ across the first main switch Sₚ₁ increases linearly.

Here, Vₛₚ₁ becomes the sum of voltage Vᵢₙ of the input capacitor Cᵢₙ and voltage V_{c1} of the first clamp capacitor C_{c1}.

A voltage spike due to resonance generated between the first leakage inductor L_{LK1} and the parasitic capacitor Cₚ₁ of the first main switch Sₚ₁ may be reduced as compared to the case according to the related art by the first clamp capacitor C_{c}.

Meanwhile, the second sub-switch Sₐ₂ of the second converter unit 120 is turned off and is maintained in a turn-off state, and current of the second main switch Sₚ₂ is in a negative state, such that current in the parasitic capacitor Cₚ₂ of the second main switch Sₚ₂ is discharged.

Here, in the case in which leakage energy of the second transformer T₂ is larger than energy charged in the parasitic capacitor Cₚ₂ of the second main switch Sₚ₂, the current continuously flows to the anti-parallel diode Dᵣ₂ of the second synchronous switch Sᵣ₂, and current corresponding to a difference between the current of the second main switch Sₚ₂ and the current of the first magnetization inductor Lₘ₁ is supplied to the output capacitor Cₒ and finally transferred to the inverter unit 130.

On the other hand, in the case in which the leakage energy of the second transformer T₂ is smaller than the energy charged in the parasitic capacitor Cₚ₂ of the second main switch Sₚ₂, the second magnetization inductor Lₘ₂ also contributes to a soft switching operation of the second main switch Sₚ₂.

Finally, when the current of the second main switch Sₚ₂ becomes equal to that of the second magnetization inductor Lₘ₂, induction of the current to the second secondary side is not generated.

<Mode 5>

The first synchronous switch Sᵣ₁ of the first converter unit 110 is turned on and is maintained in a turn-on state.

Therefore, the energy accumulated in the first magnetization inductor Lₘ₁ is induced to the first secondary coil L₁′, and the induced current is charged in the output capacitor C₀ through the first synchronous switch Sᵣ₁ and finally transferred to the inverter unit 130. At this time, current corresponding to a difference between the current of the first magnetization inductor Lₘ₁ and the current of the first main switch Sₚ₁ is induced to the first secondary coil L₁′.

In addition, leakage energy of the first transformer T₁, that is, energy accumulated in the first leakage inductor L_{LK1} is absorbed in the first clamp capacitor C_{c1}.

Meanwhile, in the second converter unit 120, all of the current in the parasitic capacitor Cₚ₂ of the second main switch Sₚ₂ is discharged to thereby become 0, such that a soft switching operation may be performed at a point of time at which the second main switch Sₚ₂ is turned on.

After Mode 5, operation processes of Mode 1 to Mode 5 described above are reversely performed in the first and second converter units 110 and 120. In other words, the operation of the first converter unit 110 described above is performed in the second converter unit 120, and the operation of the second converter unit 120 described above is performed in the first converter unit 110. Therefore, an overlapped description will be omitted.

This process may be implemented by the control signals controlling the turn-on or turn-off of the first main switch Sₚ₁, the first sub-switch Sₐ₁, the first synchronous switch Sᵣ₁, the second main switch Sₚ₂, the second sub-switch Sₐ₂, and the second synchronous switch Sᵣ₂, and these control signals may be generated by the separately provided controlling unit (not shown) and be applied to each switch.

Meanwhile, a method for controlling a converter according to the exemplary embodiment of the present invention may include (a) turning on the first main switch Sₚ₁ in a state in which the second synchronous switch Sᵣ₂ is turned on; (b) turning on the second sub-switch after turning off the second synchronous switch Sᵣ₂; (c) turning on the first synchronous switch Sᵣ₁ after turning off the first main switch Sₚ₁ and the second sub-switch; (d) turning on the second main switch Sₚ₂ in a state in which the first synchronous switch Sᵣ₁ is turned on; (e) turning on the first sub-switch after turning off the first synchronous switch Sᵣ₁; and (f) turning on the second synchronous switch Sᵣ₂ after turning off the second main switch Sₚ₂ and the first sub-switch.

Here, step (a) corresponds to Mode 1 described above, step (b) corresponds to Mode 3 described above, step (c) corresponds to Mode 4 described above, step (d) corresponds to Mode 5 described above, step (e) corresponds to a case in which the second converter unit 120 performs an operation of the first converter unit 110 in Mode 2 described above and the first converter unit 110 performs an operation of the second converter unit 120 in Mode 2 described above, and step (f) corresponds to a case in which the second converter unit 120 performs an operation of the first converter unit 110 in Mode 4 described above and the first converter unit 110 performs an operation of the second converter unit 120 in Mode 4 described above.

Through the above-mentioned process, the first and second converter units 110 and 120 alternately perform converting processes, thereby making it possible to reduce a ripple of input current and withstand voltages of various elements provided in the converter.

In addition, the first active clamp unit 111, the first synchronous rectifying unit 112, the second active clamp unit 121, and the second synchronous rectifying unit 122 are provided and operated in the above-mentioned scheme, thereby making it possible to reduce a voltage spike of the first and second main switches Sₚ₁ and Sₚ₂ due to a parasitic resonance phenomenon generated between the first leakage inductor L_{LK1} and the parasitic capacitor Cₚ₁ of the first main switch Sₚ₁ and between the second leakage inductor L_{LK2} and the parasitic capacitor Cₚ₂ of the second main switch Sₚ₂.

In addition, since the leakage energy accumulated in the first and second leakage inductors L_{LK1} and L_{LK2} may be transferred to the output capacitor Cₒ through the anti-parallel diode Dᵣ₁ of the first synchronous switch Sᵣ₁ and the anti-parallel diode Dᵣ₂ of the second synchronous switch Sᵣ₂, energy efficiency may be improved by at least 1 to 2%.

Further, the energy accumulated in the first and second magnetization inductors Lₘ₁ and Lₘ₂, which is relative large energy, is transferred to the output capacitor Cₒ through the first synchronous switch Sᵣ₁ and the second synchronous switch Sᵣ₂, and the leakage energy accumulated in the first and second leakage inductors L_{LK1} and L_{LK2}, which is relatively small energy is transferred to the output capacitor Cₒ through the anti-parallel diode Dᵣ₁ of the first synchronous switch Sᵣ₁ and the anti-parallel diode Dᵣ₂ of the second synchronous switch Sᵣ₂.

Therefore, stress applied to the diode may be reduced as compared to the case according to the related art in which only an output diode is provided in a secondary side, and a diode having low withstand voltage may be used.

Here, since loss of the switch is generally larger than that of the diode, the diode is allowed to be used during a process of transferring the leakage energy, which is the relatively small energy, thereby making it possible to reduce the energy loss.

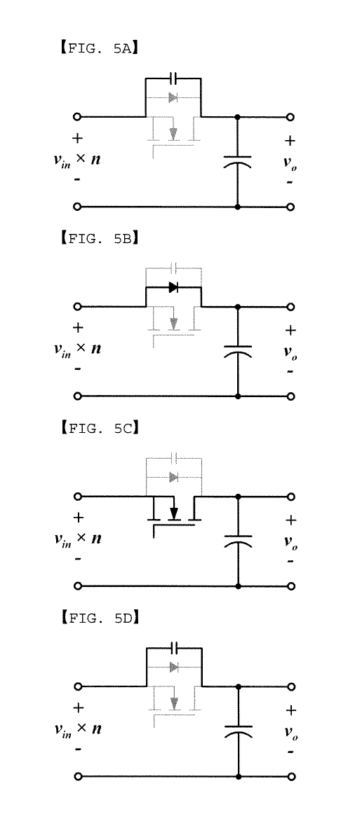

FIG. 4 is a view schematically showing operation waveforms in the case in which main elements of the inverter 100 according to the exemplary embodiment of the present invention are in a normal state.

Referring to FIG. 4, during a grid period, a gate signal V_{g}_{_{—}}_{Sp1} of the first main switch Sₚ₁ and a gate signal V_{g}_{_{—}}_{Sa1} of the first sub-switch Sₐ₁ are generated. When the first main switch Sₚ₁ is turned on, current of the first main switch Sₚ₁ increases linearly up to a command current waveform having a similar shape to that of rectified grid voltage. In addition, when the current of the first main switch Sₚ₁ becomes equal to the command current waveform, the first main switch Sₚ₁ is turned off and voltage of the first main switch increases up to a preset voltage. Here, the preset voltage is the same as the sum of a clamped voltage spike, input voltage, and feedback voltage.

Meanwhile, the energy stored in the first magnetization inductor Lₘ₁ is transferred to the grid when the first synchronous switch Sᵣ₁ is turned on.

In addition, after the first synchronous switch Sᵣ₁ is turned off, the first sub-switch Sₐ₁ is turned on in order to transfer the energy accumulated in the first leakage inductor L_{LK1} by the first clamp capacitor C_{c1} to the grid.

This process is repeatedly performed equally in the second converter unit 120 in a state in which a phase is delayed by 180 degrees.

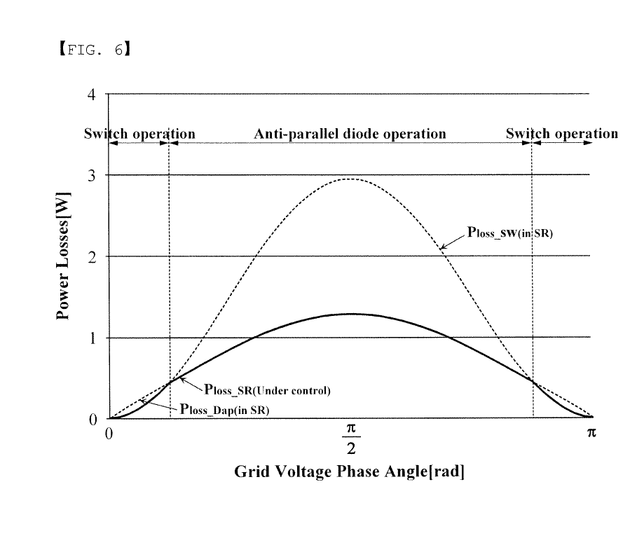

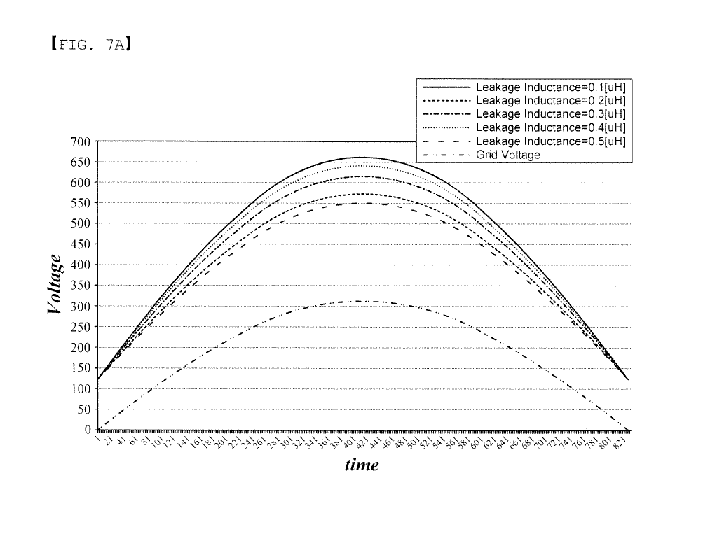

FIGS. 5A to 5D are views describing an operation mode of a synchronous rectifying unit of the converter according to the exemplary embodiment of the present invention.

Referring to FIGS. 5A to 5D, FIG. 5A shows a case in which a parasitic capacitor Cp of a switch is charged with energy flowing through a line, and FIG. 5B shows a process in which an anti-parallel diode D of a switch is conducted for soft-switching. As shown in FIG. 5C, a switch performs a zero-voltage switching operation.

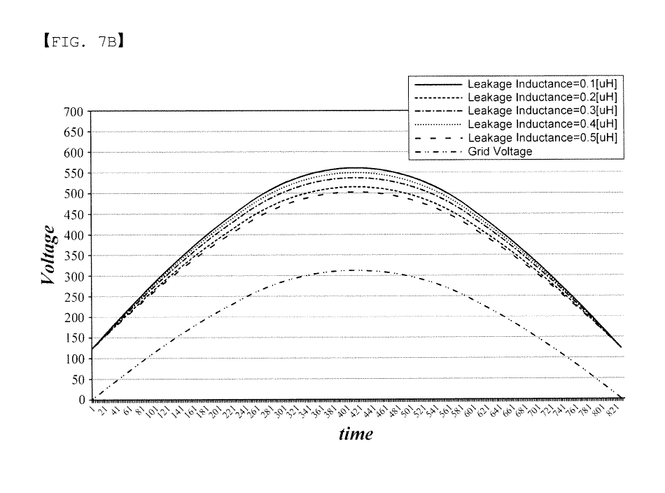

FIG. 6 is a view schematically showing a switching variable region of a synchronous rectifier during a grid voltage frequency.

Referring to FIG. 6, in a switch operation period, loss of an anti-parallel diode D is larger than that of a switch, and in an anti-parallel diode D operation period, loss of the switch is larger than that of the anti-parallel diode (D).

Therefore, it may be appreciated that the energy loss may be reduced by allowing the energy to be transferred through a path having low loss.

In addition, since a period in which the loss of the switch is smaller than that of the anti-parallel diode (D) is narrower in a single flyback inverter 100 than in an interleaved flyback inverter 100, when the single flyback converter 100 separately operates in the switch operation period and the anti-parallel diode (D) operation period, an efficiency improvement effect is low.

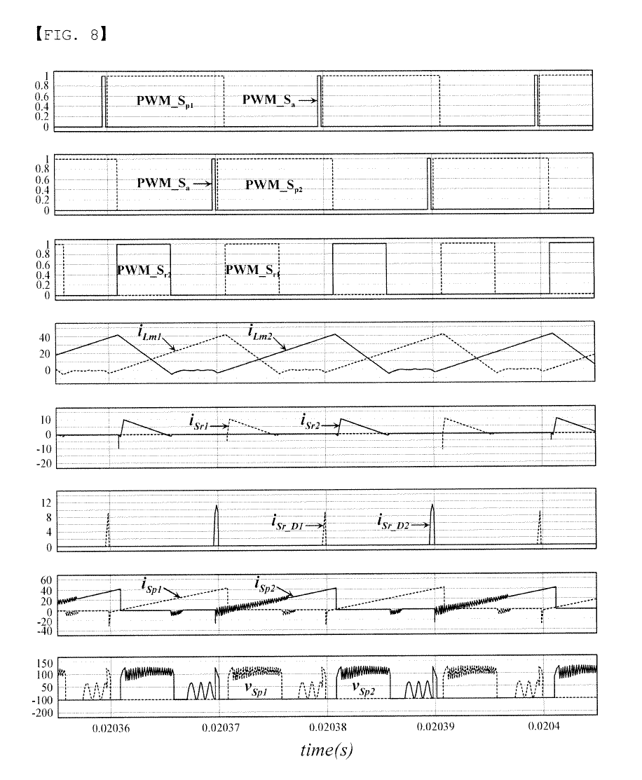

FIG. 7A is a view schematically showing voltage waveforms of a synchronous switch during a process in which a leakage inductor of a single flyback inverter 100 is charged with current; and FIG. 7B is a view schematically showing voltage waveforms of a synchronous switch during a process in which a leakage inductor of an interleaved flyback inverter 100 is charged with current.

Referring to FIGS. 7A and 7B, a voltage peak component applied to the synchronous switch is smaller in the interleaved flyback converter 100 than in the single flyback converter 100.

Therefore, in the converter and the inverter 100 according to the exemplary embodiment of the present invention, a MOS transistor, or the like, having low voltage characteristics as compared to the general signal flyback inverter 100 according to the related art may be used as a synchronous switch.

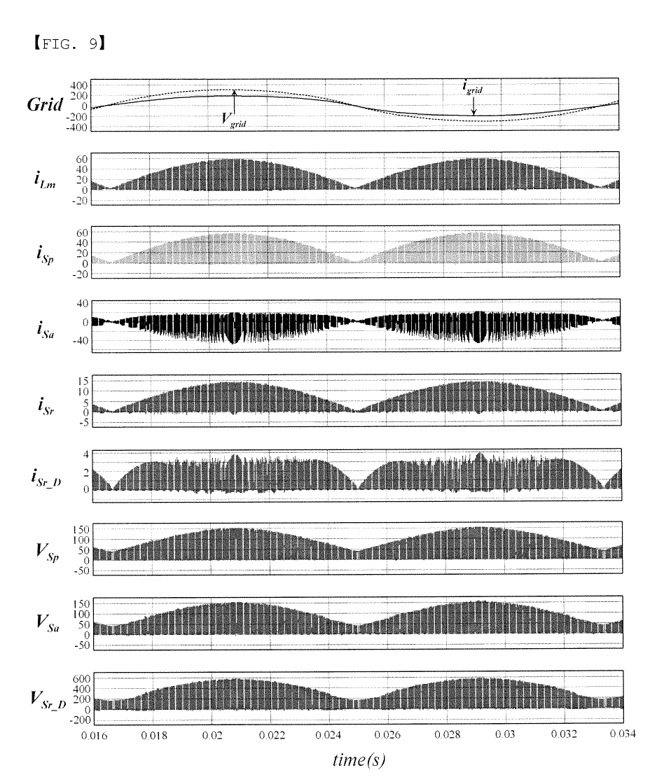

FIG. 8 is a view schematically showing simulation results of operation waveforms in main elements of the converter according to the exemplary embodiment of the present invention during a switching period; and FIG. 9 is a view schematically showing simulation results of operation waveforms in main elements of the inverter 100 according to the exemplary embodiment of the present invention during a grid period.

Referring to FIGS. 8 and 9, it could be confirmed that FIG. 3 referred in order to describe the operation principle of the converter according to the exemplary embodiment of the present invention and FIG. 4 referred to describe an effect thereof coincide with actual simulation results.

With the converter, the method for controlling the same, the inverter according to the exemplary embodiments of the present invention configured as described above, the power loss due to the leakage flux, the voltage spike generated in the switch, the stress applied to the secondary side diode and the output capacitor, and the switching conduction loss may be reduced.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. A converter comprising:
an input terminal having power input thereto;
a first converter unit converting the power input to the input terminal to thereby output the converted power to an output terminal; and
a second converter unit connected between the input terminal and the output terminal while being in parallel with the first converter unit,
wherein each of the first and second converter units includes an active clamp unit provided at a primary side thereof and a synchronous rectifying unit provided at a secondary side thereof.

2. The converter according to claim 1, wherein each of the first and second converter units includes:
a primary coil having one end connected to the input terminal;
a main switch having a first terminal connected to the other end of the primary coil and a second terminal connected to the input terminal; and
a secondary coil magnetically coupled to the primary coil and having one end connected to the output terminal.

3. The converter according to claim 2, wherein the active clamp unit includes:
a sub-switch having a first terminal connected between the input terminal and the primary coil; and
a clamp capacitor having one end connected to a second terminal of the sub-switch and the other end connected between the primary coil and the main switch.

4. The converter according to claim 3, wherein the main switch and the sub-switch are provided with an anti-parallel diode.

5. The converter according to claim 2, wherein the synchronous rectifying unit includes:
a synchronous switch connected between the other end of the secondary coil and the output terminal; and
an anti-parallel diode connected to the synchronous switch.

6. The converter according to claim 4, wherein the synchronous rectifying unit includes:
a synchronous switch connected between the other end of the secondary coil and the output terminal; and
an anti-parallel diode connected to the synchronous switch.

7. The converter according to claim 6, wherein the synchronous switch is changed from a turn-off state to a turn-on state after the main switch is changed from a turn-on state to a turn-off state,
the sub-switch is changed from a turn-off state to a turn-on state after the synchronous switch is changed from the turn-on state to the turn-off state, and
the main switch is changed from the turn-off state to the turn-on state after the sub-switch is changed from the turn-on state to the turn-off state.

8. The converter according to claim 7, wherein the main switch of the second converter unit becomes the turn-on state only in the case in which the main switch of the first converter unit is in the turn-off state.

9. The converter according to claim 8, wherein a time in which the synchronous switch of the first converter unit is turned on is prior to a time in which the main switch of the second converter unit is turned on, and
a time in which the synchronous switch of the first converter unit is turned off is between a time in which the main switch of the second converter unit is turned on and a time in which the sub-switch of the first converter unit is turned on.

10. A converter comprising:
an input terminal having power input thereto;
a first primary coil having one end connected to the input terminal;
a first main switch having a first terminal connected to the other end of the first primary coil and a second terminal connected to the input terminal;
a first active clamp unit connected in parallel with the first primary coil;
a first secondary coil magnetically coupled to the first primary coil and having one end connected to an output terminal;
a first synchronous switch having a first terminal connected to the other end of the first secondary coil and a second terminal connected to the output terminal;
a second primary coil having one end connected to the input terminal;
a second main switch having a first terminal connected to the other end of the second primary coil and a second terminal connected to the input terminal;
a second active clamp unit connected in parallel with the second primary coil;
a second secondary coil magnetically coupled to the second primary coil and having one end connected to an output terminal; and
a second synchronous switch having a first terminal connected to the other end of the second secondary coil and a second terminal connected to the output terminal.

11. The converter according to claim 10, wherein the first active clamp unit includes:
a first sub-switch having a first terminal connected between the first primary coil and the input terminal; and
a first clamp capacitor having one end connected to a second terminal of the first sub-switch and the other end connected between the first primary coil and the first main switch, and
wherein the second active clamp unit includes:
a second sub-switch having a first terminal connected between the second primary coil and the input terminal; and
a second clamp capacitor having one end connected to a second terminal of the second sub-switch and the other end connected between the second primary coil and the second main switch.

12. The converter according to claim 11, further comprising an anti-parallel diode connected to each of the first main switch, the first sub-switch, the second main switch, and the second sub-switch.

13. The converter according to claim 12, further comprising an anti-parallel diode connected to each of the first and second synchronous switches.

14. The converter according to claim 13, wherein the first synchronous switch is changed from a turn-off state to a turn-on state after the first main switch and the second sub-switch are changed from a turn-on state to a turn-off state,
the second main switch is changed from a turn-off state to a turn-on state in a state in which the first synchronous switch is turned on,
the first sub-switch is changed from a turn-off state to a turn-on state after the first synchronous switch is changed from the turn-on state to the turn-off state,
the second synchronous switch is changed from a turn-off state to a turn-on state after the first sub-switch and the second main switch are changed from the turn-on state to the turn-off state, and
the first main switch is changed from the turn-off state to the turn-on state in a state in which the second synchronous switch is turned on.

15. An inverter comprising:
the converter according to claims 1 or 10;
an output capacitor connected to the output terminal; and
an inverter unit connected in parallel with the output capacitor and converting direct current into alternate current.

16. The inverter according to claim 15, further comprising a filter unit connected to the inverter unit and removing noise.

17. A method for controlling the converter according to claim 13, the method comprising:
(A) turning on the first main switch, thereby supplying current to the first primary coil;
(B) turning on the first synchronous switch after turning off the first main switch, thereby transferring current induced to the first primary coil to the output terminal;
(C) turning on the first sub-switch after turning off the first synchronous switch; and
(D) turning off the first sub-switch.

18. A method for controlling the converter according to claim 13, the method comprising:
(a) turning on the first main switch in a state in which the second synchronous switch is turned on;
(b) turning on the second sub-switch after turning off the second synchronous switch;
(c) turning on the first synchronous switch after turning off the first main switch and the second sub-switch;
(d) turning on the second main switch in a state in which the first synchronous switch is turned on;
(e) turning on the first sub-switch after turning off the first synchronous switch; and
(f) turning on the second synchronous switch after turning off the second main switch and the first sub-switch.
